(19) United States
(12) Patent Application Publication
(10) Pub. No.: US 2013/0162758 A1
(43) Pub. Date: Jun. 27, 2013

(54) VIDEO CONFERENCE CONTROL SYSTEM AND METHOD FOR RESERVING VIDEO CONFERENCE

(71) Applicant: Electronics and Telecommunications Research Institute, Daejeon (KR)

(72) Inventor: Young Soo SHIN, Daejeon (KR)

(73) Assignee: Electronics and Telecommunications Research Institute, Daejeon (KR)

(21) Appl. No.: 13/727,942

(22) Filed: Dec. 27, 2012

(30) Foreign Application Priority Data
Dec. 27, 2011 (KR) 10-2011-0143829

(51) Int. Cl. H04N 7/15

(52) U.S. Cl. CPC H04N 7/152
USPC 348/14.09

(57) ABSTRACT

Disclosed is a video conference control system which includes a video conference reserving device which receives video conference reservation resource data; a multipoint controller which collects resource data for a video conference according to the video conference reservation resource data to generate a resource management policy; and a multipoint processor which provides a plurality of terminals with a resource for a video conference according to the resource management policy.

### CROSS-REFERENCE TO RELATED APPLICATIONS

A claim for priority under 35 U.S.C. §119 is made to Korean Patent Application No. 10-2011-0143829 filed Dec. 27, 2011, in the Korean Intellectual Property Office, the entire contents of which are hereby incorporated by reference.

### BACKGROUND

The inventive concepts described herein relate to a video conference control system, and more particularly, relate to a multipoint video conference control system.

For remote users to conduct a video conference through a network, a device may be needed which transfers information of each user (e.g., a voice, an image, data, etc.) to other users.

A multipoint conference unit may be a device capable of supporting a multipoint video conference, and may be formed of a multipoint controller and a multipoint processor.

The number of users capable of participating in a video conference in maximum may be determined according to an information processing capacity of the multipoint conference unit, and a constant bandwidth may be required for a smooth video conference. If a bandwidth is not secured appropriately, an image and voice disconnection phenomenon may arise. Image data stored at a terminal may be retransmitted through buffering when network jam or delay arises. However, since data generated at a video conference may be retransmission-impossible real-time data, it may be impossible to restore it when network jam or delay arises. For this reason, a reliable multipoint video conference control system may be required.

### SUMMARY

Example embodiments of the inventive concept provide a video conference control system comprising a video conference reserving device which receives video conference reservation resource data; a multipoint controller which collects resource data for a video conference according to the video conference reservation resource data to generate a resource management policy; and a multipoint processor which provides a plurality of terminals with a resource for the video conference according to the resource management policy.

In example embodiments, the multipoint controller and the multipoint processor are connected through a network.

In example embodiments, the multipoint controller processes the collected resource data as information for resource management to generate the resource management policy suitable for a video conference through analyzing, learning, and inferring.

In example embodiments, the resource management policy includes a transfer data translation policy and a band width for the video conference.

In example embodiments, the multipoint processor is plural and the plurality of multipoint processors is mutually connected through the network.

In example embodiments, the plurality of terminals is connected to corresponding multipoint processors through the network, respectively.

In example embodiments, the video conference reservation resource data includes the video conference start time, the video conference end time, and location data of participators.

Example embodiments of the inventive concept also provide a video conference reserving method which comprises receiving video conference reservation resource data; collecting resource data distributed at a plurality of network resource utilizing systems; processing the collected resource data to manageable information; generating optimum resource management information from the processed information; and establishing a resource management policy for execution of a video conference from the resource management information.

In example embodiments, the video conference reservation resource data includes a video conference start time, the video conference end time, and location data of participators.

In example embodiments, the generating optimum resource management information from the processed information comprises analyzing, learning, and inferring the processed information; and generating optimum resource management information for a video conference by analyzing, learning, and inferring of the processed information.

In example embodiments, the establishing a resource management policy for execution of a video conference from the resource management information comprises establishing a bandwidth for the video conference.

In example embodiments, the video conference reservation resource data further comprises information associated with a resource for a video conference, and the establishing a resource management policy for execution of a video conference from the resource management information further comprises establishing a resource management policy for supporting a resource for the video conference.

In example embodiments, the establishing a resource management policy for execution of a video conference from the resource management information further comprises storing the established resource management policy at a memory; and printing the established resource management policy.

In example embodiments, the video conference reserving method further comprises providing a resource such that the video conference is performed according to the resource management policy.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a diagram schematically illustrating a video conference control system according to an embodiment of the inventive concept.

FIG. 2 is a diagram schematically illustrating a video conference control system according to another embodiment of the inventive concept.

FIG. 3 is a diagram schematically illustrating a video conference control system according to still another embodiment of the inventive concept.

FIG. 4 is a flowchart illustrating an operation of a video conference control system in FIG. 3.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

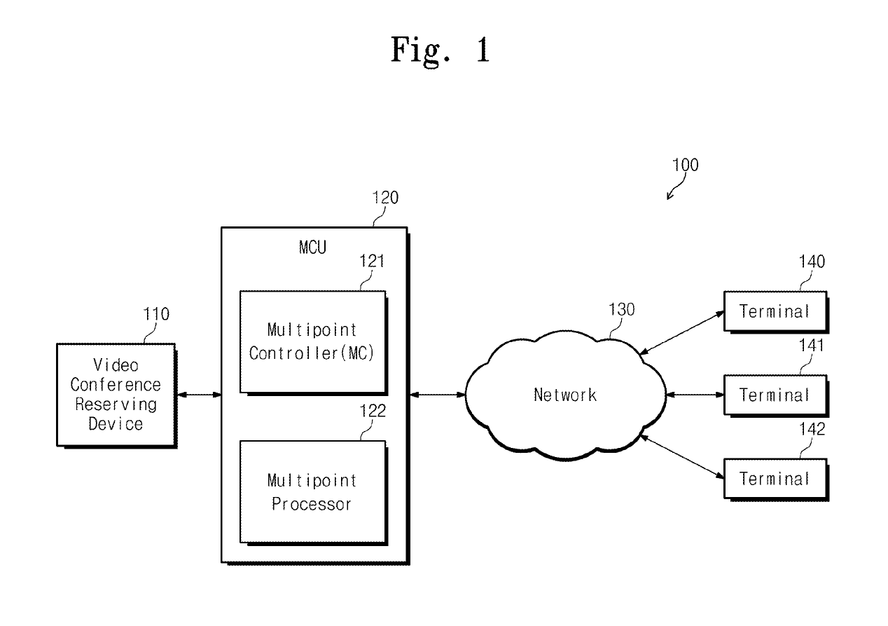

FIG. 1 is a diagram schematically illustrating a video conference control system according to an embodiment of the inventive concept.

Referring to FIG. 1, a video conference control system 100 may include a video conference reserving device 110 and a multipoint conference unit (MCU) 120. The multipoint conference unit 120 may be a device which supports a multipoint video conference, and may include a multipoint controller (MC) 121 and a multipoint processor (MP) 122. The multipoint conference unit 120 may be connected with terminals 140 to 142 through a network 130. The number of terminals capable of being connected with the multipoint conference unit 120 through the network 130 may be changed variously, not limited to 3.

The network 130 may be a private telecommunication network or an internet. Each of the terminals 140 to 142 may be a personal terminal such as a personal computer, a notebook, a tablet PC, or the like. Each of the terminals 140 to 142 may include a camera for receiving a video signal, a microphone for receiving a voice signal, a display device for outputting a video signal, a speaker for outputting a voice signal, and the like. A part of the terminals 140 to 142 may further include additional devices such as an interactive board, a slide screen, a facsimile, a printer, and the like.

The multipoint controller 121 may control an overall operation (e.g., video conference establishing, maintaining, closing, etc.) by making section construction on the terminals 140 to 142 participating in a multipoint conference.

The multipoint controller 121 may be implemented by a software module, and may exist at a gateway, a gatekeeper, or a terminal.

The multipoint processor 122 may receive images, voices, and data from the terminals 140 to 142 to mix or exchange input information to be distributed. For example, if codecs of the terminals 140 to 142 participating in a video conference are different, the multipoint processor 122 may perform a translation operation such that voice or video traffic codecs coincide with each other. When transfer speeds of the terminals 140 to 142 participating in a video conference are different, the multipoint processor 122 may adjust a traffic speed. That is, the multipoint processor 122 may process media data such as images, voices, and data. Preferably, the multipoint processor 122 may be implemented by hardware.

The multipoint controller 121 and the multipoint processor 122 may be separated functionally to have an independent system structure. This may enable desired functions to be added independently upon expanding of the video conference control system 100. Thus, it is possible to construct a high-priced system using a low-priced system.

The video conference reserving device 110 may collect information on a video conference to be held later, and may transfer video conference information to the multipoint conference unit 120. For example, a user holding a video conference may input information associated with a video conference through the video conference reserving device 110. The video conference reserving device 110 may transfer video conference reservation information to the multipoint conference unit 120. The multipoint conference unit 120 may make resource management according to the input video conference reservation information such that a video conference is smoothly performed.

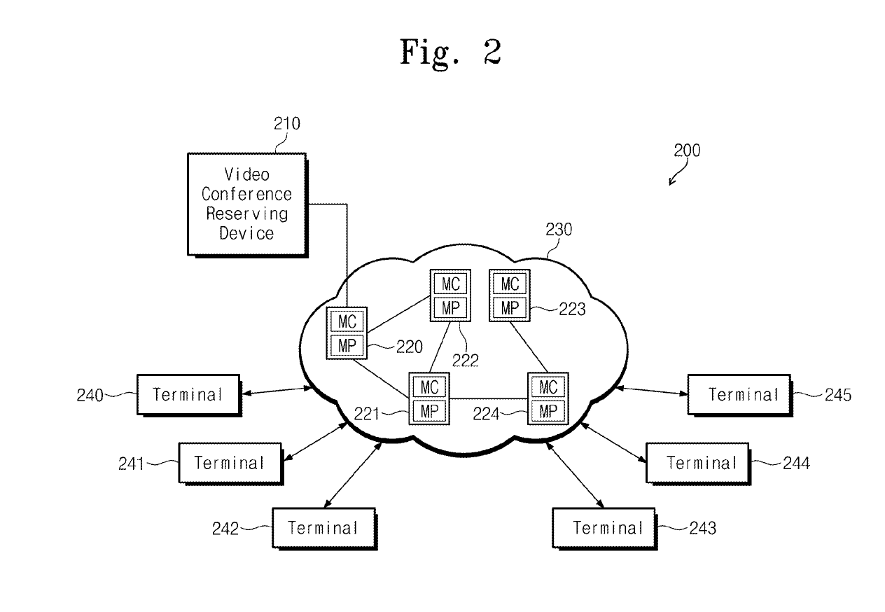

FIG. 2 is a diagram schematically illustrating a video conference control system according to another embodiment of the inventive concept.

Referring to FIG. 2, a video conference control system 200 may include a video conference reserving device 210 and a plurality of multipoint conference units 220 to 224. The multipoint conference units 220 to 224 may be located at different places, and may be mutually connected through a network 230. Each of the multipoint conference units 220 to 224 may be a device capable of supporting a multipoint video conference, and may include a multipoint controller MC and a multipoint processor MP. The multipoint conference units 220 to 224 may be connected with the network 230. The number of terminals capable of being connected with the multipoint conference units 220 to 224 through the network 230 may be changed variously, not limited to 6. Each of the terminals 240 to 245 may be connected with a corresponding one of the multipoint conference units 220 to 224 through the network 230. For example, each of the terminals 240 to 245 may be connected with a multipoint conference unit which is located closely or is predetermined.

One (e.g., 220) of the multipoint conference units 220 to 224 may be connected with the video conference reserving device 210. A multipoint controller MC in the multipoint conference unit 220 connected with the video conference reserving device 210 may process an operation associated with video conference reservation. Multipoint processor MP in the multipoint conference units 221 to 224 not connected with the video conference reserving device 210 may perform a function of a multipoint processor MP as a main operation.

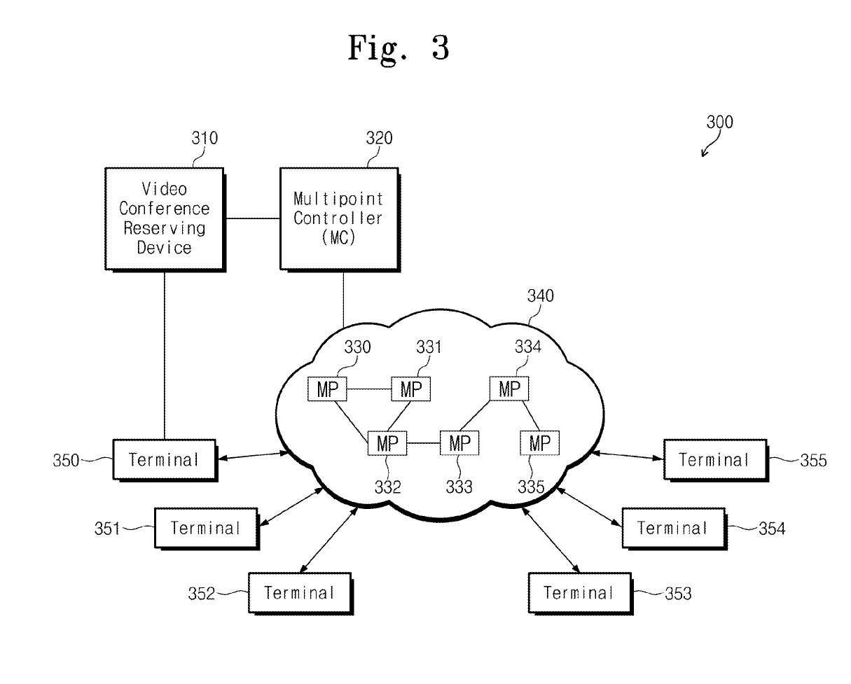

FIG. 3 is a diagram schematically illustrating a video conference control system according to still another embodiment of the inventive concept.

Referring to FIG. 3, a video conference control system 300 may include a video conference reserving device 310, a multipoint controller (MC) 320, and a plurality of multipoint processors 330 to 335. The multipoint processors 330 to 335 may be mutually connected through a network 340. The multipoint controller 320 may be connected with terminals 350 to 355 through the multipoint processors 330 to 335 and the network 340. The number of terminals capable of being connected with the multipoint controller 320 through the network 340 may be changed variously, not limited to 6.

The network 340 may be a private telecommunication network or an internet. Each of the terminals 350 to 355 may be a personal terminal such as a personal computer, a notebook, a tablet PC, or the like. Each of the terminals 350 to 355 may include a camera for receiving a video signal, a microphone for receiving a voice signal, a display device for outputting a video signal, a speaker for outputting a voice signal, and the like. A part of the terminals 350 to 355 may further include additional devices such as an interactive board, a slide screen, a facsimile, a printer, and the like.

The multipoint controller 320 may control an overall operation (e.g., video conference establishing, maintaining, closing, etc.) by making section construction on the terminals 350 to 355 participating in a multipoint conference. The multipoint controller 320 may be implemented by a software module, and may exist at a gateway, a gatekeeper, or a terminal.

The multipoint processors 330 to 335 may receive images, voices, and data from the terminals 350 to 355 to mix or exchange input information to be distributed. For example, if codecs of the terminals 350 to 355 participating in a video conference are different, each of the multipoint processors 330 to 335 may perform a translation operation such that voice or video traffic codecs coincide with each other. When transfer speeds of the terminals 350 to 355 participating in a video conference are different, each of the multipoint processors 330 to 335 may adjust a traffic speed. That is, the multipoint processors 330 to 335 may process media data such as images, voices, and data. Preferably, the multipoint processors 330 to 335 may be implemented by hardware.

In example embodiments, the multipoint processors 330 to 335 may be separated from the multipoint controller 320 to have an independent system structure. This may enable media data on the terminals 350 to 355 distributed at a wide area to be processed efficiently.

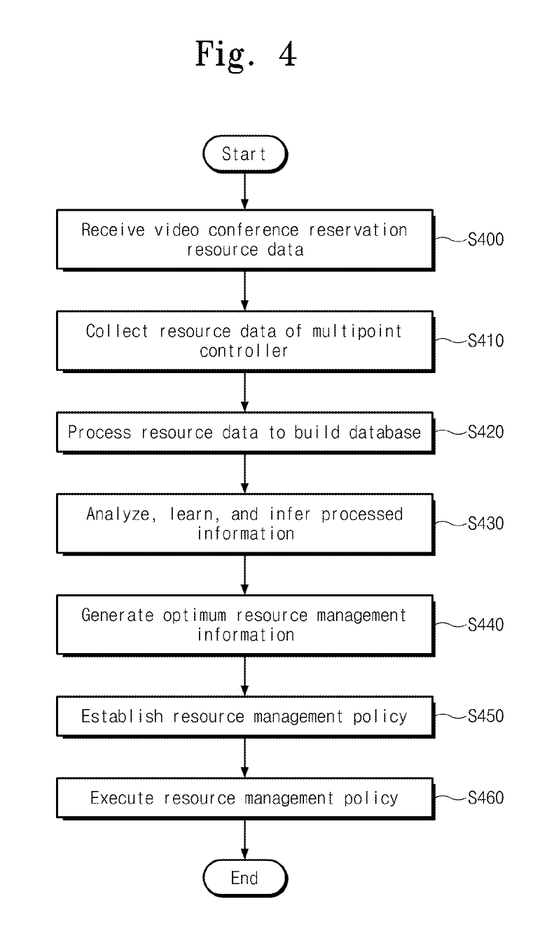

FIG. 4 is a flowchart illustrating an operation of a video conference control system in FIG. 3.

Referring to FIGS. 3 and 4, in operation S400, a video conference reserving device 310 may provide a multipoint controller 320 with video conference reservation resource data input by a user. The input video conference reservation resource data may include a video conference start time, a video conference end time, participator's location data, and the like. The location data may include information of terminals 350 to 355 of users participating in a video conference. For example, the video conference reserving device 310 may be directly connected with a terminal 350 such that video conference reservation resource data is input through the terminal 350.

To provide a smooth video conference service, a bandwidth for a video conference may be secured sufficiently, and advance preparation may be needed to support a desired resource. In particular, a bandwidth for a video conference may be secured in advance when many users participate in a video conference or to provide an HD-level image service.

In operation S410, the multipoint controller 320 may collect data on necessary resources based on video conference reservation data. For example, the multipoint controller 320 may collect a codec type of each terminal, month/time/day-based average traffics of a reserved video conference time, or data associated with another reserved video conference. In operation S420, the multipoint controller 320 may process data, needed to establish a resource management policy, from of the collected resource data to build a database.

In operation S430, the multipoint controller 320 may analyze, learn, and infer the processed information. This may be performed by artificial intelligence software. In operation S440, the multipoint controller 320 may generate resource management information to provide an optimum resource to reserved participators, that is, terminals 350 to 355. The multipoint controller 320 may transfer the resource management information to the video conference reserving device 310 such that subscribers see the resource management information. A video conference manager may confirm resource management information stored at a memory (not shown) in the video conference reserving device 310 through a monitor (not shown), or may print it. Thus, the video conference manager may instinctively acquire information associated with a management environment.

If a video conference reserved by the video conference manager is not cancelled or revised, in operation S450, the multipoint controller 320 may set the resource management information to a resource management policy. The determined resource management policy can be used as resource data according to reservation of another video conference. The resource management policy may include a bandwidth for a video conference, resource supporting information for a video conference, a transfer data translation policy, and the like.

A final resource management policy may be sent to the video conference reserving device 310 by the multipoint controller 320. The video conference manager may confirm resource management information stored at a memory (not shown) in the video conference reserving device 310 through a monitor (not shown), or may print it.

When it is a reserved time, in operation S460, the multipoint processors 330 to 335 may provide resources to terminals 350 to 355 according to the resource management policy of the multipoint controller 320. For example, it is possible to hold a high-quality video conference by providing a network bandwidth to the terminals 350 to 355 from the multipoint processors 330 to 335 according to the resource management policy and preventing an invasion by other systems or terminals.

At a point of time when a video conference is ended, the multipoint controller 320 may update information associated with resourced used at a video conference to be used as resource data needed for a next video conference. Thus, it is possible to improve reliability of resource management of the multipoint controller 320.

As described above, a video conference control system of the inventive concept may support a video conference reservation function, and may provide a high-quality multipoint video conference service by utilizing resources in maximum.

While the inventive concept has been described with reference to exemplary embodiments, it will be apparent to those skilled in the art that various changes and modifications may be made without departing from the spirit and scope of the present invention. Therefore, it should be understood that the above embodiments are not limiting, but illustrative.

What is claimed is:

1. A video conference control system comprising:
a video conference reserving device which receives video conference reservation resource data;
a multipoint controller which collects resource data for a video conference according to the video conference reservation resource data to generate a resource management policy; and
a multipoint processor which provides a plurality of terminals with a resource for the video conference according to the resource management policy.

2. The video conference control system of claim 1, wherein the multipoint controller and the multipoint processor are connected through a network.

3. The video conference control system of claim 2, wherein the multipoint controller processes the collected resource data as information for resource management to generate the resource management policy suitable for the video conference through analyzing, learning, and inferring.

4. The video conference control system of claim 3, wherein the resource management policy includes a transfer data translation policy and a band width for the video conference.

5. The video conference control system of claim 2, wherein the multipoint processor is plural and the plurality of multipoint processors is mutually connected through the network.

6. The video conference control system of claim 5, wherein the plurality of terminals is connected to corresponding multipoint processors through the network, respectively.

7. The video conference control system of claim 1, wherein the video conference reservation resource data includes the video conference start time, the video conference end time, and location data of participators.

8. A video conference reserving method comprising:
receiving video conference reservation resource data;
collecting resource data distributed at a plurality of network resource utilizing systems;
processing the collected resource data to manageable information;
generating optimum resource management information from the processed information; and
establishing a resource management policy for execution of a video conference from the resource management information.

9. The video conference reserving method of claim 8, wherein the video conference reservation resource data includes a video conference start time, a video conference end time, and location data of participators.

10. The video conference reserving method of claim 8, wherein the generating optimum resource management information from the processed information comprises:
analyzing, learning, and inferring the processed information; and
generating optimum resource management information for a video conference by analyzing, learning, and inferring of the processed information.

11. The video conference reserving method of claim 8, wherein the establishing a resource management policy for execution of a video conference from the resource management information comprises establishing a bandwidth for the video conference.

12. The video conference reserving method of claim 11, wherein the video conference reservation resource data further comprises information associated with a resource for a video conference, and
wherein the establishing a resource management policy for execution of a video conference from the resource management information further comprises establishing a resource management policy for supporting a resource for a video conference.

13. The video conference reserving method of claim 12, wherein the establishing a resource management policy for execution of a video conference from the resource management information further comprises:
storing the established resource management policy at a memory; and
printing the established resource management policy.

14. The video conference reserving method of claim 8, further comprising:
providing a resource such that the video conference is performed according to the resource management policy.
